(19) United States
(12) Patent Application Publication
(10) Pub. No.: US 2023/0341527 A1
(43) Pub. Date: Oct. 26, 2023

(54) LASER DETECTION AND RANGING (LIDAR) DEVICE

(71) Applicant: OUTSIGHT, Paris (FR)

(72) Inventors: Albert MANNINEN, Paris (FR); Priit JAANSON, Paris (FR)

(21) Appl. No.: 17/797,573

(22) PCT Filed: Feb. 5, 2021
(86) PCT No.: PCT/EP2021/052847

§ 371 Date: Aug. 4, 2022

Related U.S. Application Data
(60) Provisional application No. 62/970,350, filed on Feb. 5, 2020.

(51) Int. Cl. G01S 7/4861; G01S 7/481; G01S 7/4865; G01S 7/484

(52) U.S. Cl. CPC G01S 7/4861; G01S 7/4818; G01S 7/4865; G01S 7/484; G01S 7/4812

(57) ABSTRACT

Disclosed is a laser detection and ranging, or LiDAR, device, including a transceiver assembly adapted to steer an incoming laser signal including a pulse-train of successive laser pulses onto a target, wherein an optical energy of a trigger pulse in the pulse-train is higher than the optical energy of the majority of the pulses.

### CROSS-REFERENCE TO RELATED APPLICATIONS

This application is the U.S. national phase of International Application No. PCT/EP2021/052847 filed Feb. 5, 2021 which designated the U.S. and claims priority to U.S. 62/970,350 filed Feb. 5, 2020, the entire contents of each of which are hereby incorporated by reference.

### BACKGROUND OF THE INVENTION

### Field of the Invention

The invention relates to LiDAR devices, and more particularly, to LiDAR devices operating for long-distance remote sensing.

### Description of the Related Art

Light detection and ranging (LiDAR) systems are used to detect and/or measure distances of remote objects. A LiDAR includes a light source, such as a laser, and an optical sensor or a plurality of optical sensors. The light source emits light pulses in a portion or portions of the electromagnetic spectrum: in the infrared, visible, or ultraviolet portions for instance. When a light pulse is reflected by an object, the LiDAR can determine the distance based on the time of flight (ToF) of a returned light pulse received by the optical sensor.

The spatial range of LiDARs are traditionally limited by the optical power of the light pulses. Such optical power is also limited by eye-safety requirements. Said limitations may impact the signal-noise ratio (SNR) for long distances.

A problem in LiDARs is to determine a ToF of a signal even in low SNR.

### SUMMARY OF THE INVENTION

Compared to the state of the art, it is provided an improved LiDAR device which enables to determine the distance of objects returning light pulses even in low SNR value situations.

Namely, determining the time of flight of a train of pulses each at different spectral channel can be difficult at low SNR levels. Especially, in case the reflectivity of the target at the first or the last wavelength band is very low, the delay error would be an increment of the delay in pulse train spacing. The improved LiDAR device prevents such delay error.

The invention provides a laser detection and ranging (LiDAR) device, comprising
a transceiver assembly adapted to steer an incoming laser signal comprising a pulse-train of successive laser pulses onto a target, wherein each pulse has a rank in the pulse-train, wherein each pulse is generated to have an optical energy, wherein the optical energy of a majority of the pulses of the pulse-train has substantially a same magnitude, and the optical energy of a trigger pulse in the pulse-train is higher than the optical energy of the majority of the pulses by a factor higher than 2, wherein the trigger pulse has a predefined rank in the pulse-train, wherein the transceiver assembly is further configured to receive a return laser signal, which is a reflection of the incoming laser signal on the target,
   the LiDAR device further comprising:
an optical detector adapted to acquire a detection signal by measuring an optical power of the return laser signal over the time,
a processing module adapted to perform a coarse detection step, comprising detecting that a measured optical power of the detection signal overcomes a predefined amplitude threshold at a trigger time, and recording the trigger time, wherein the processing module is further adapted to perform a fine detection step, comprising:
selecting a time-window with reference to the trigger time, and
identifying a reflected pulse-train in the detection signal within the time window, by identifying that the time corresponds to a detection time of a reflection of the trigger pulse.

Thanks to these features, the trigger pulse will be detected most of the time, allowing signal processing methods known for single pulses to be applied in determining the time of flight of the pulse-train.

Furthermore, a LiDAR device having such features enables an effective use of the optical energy allocated to each pulse of the pulse-train, while keeping the optical energy to an eye-safe level. Indeed, there are two energy limits:
an energy limit per pulse, as each pulse needs to be eye-safe, and
an energy limit for the train of pulses (in aggregate) as the train of pulses is sent in a relatively narrow window of time and is integrated by the eye photoreceptors, which are slow receptors. For instance, an example of eye-safe operation could be 1 microJoule pulse energy at 0.5 MHz repetition rate, 30×50 degree scanning angles and 1550 nm wavelength.

Having a stronger, yet eye-safe pulse, allows an improved SNR for distance measurements. The spectral signature is possible for higher SNR (lower energy pulses). This allows to allocate the “eye-safe energy budget” in priority to make a distance measurement over the material composition estimation.

One would understand that a reflection of the incoming laser signal refers to either backscattered or specular reflection or combination thereof.

The following features, can be optionally implemented, separately or in combination one with the others:

In embodiments, the processing module further calculates the ToF of the pulse-train by comparison between an emission time of the trigger pulse and the trigger time.

In embodiments, the processing module comprises an analogical to digital converter configured to convert the detection signal into couples of numerical values, each couple associating a timestamp to a measured signal amplitude.

In embodiments, the incoming laser signal is a multispectral laser signal having a spectral range, and wherein each pulse in the incoming pulse-train has a pulse bandwidth centered on a different wavelength within the spectral range.

One can design the pulse-train in order to have a higher intensity of the trigger pulse spectrally centered on a particular wavelength by different manners. For instance, one can set a higher level of energy at the particular wavelength of the trigger pulse. Alternatively, or in addition, the pulse bandwidth of the trigger pulse is broader than the pulse bandwidth of the majority of the pulses.

Advantageously, the frequency band (or wavelengths) is optimized for propagation through atmosphere and reflection on most surfaces. In this configuration, the strongest pulse can be designed to avoid absorption band of e.g. H2O. For instance,

In embodiments, the trigger pulse is spectrally centered on a wavelength which propagates through atmosphere with low attenuation. For example, the central wavelength of the trigger pulse may be 1064 nm or 1550 nm, both having low atmospheric absorption and could be used for the trigger pulse, which is a high-intensity pulse. There are a few spectral bands in which the central wavelength of the trigger pulse may be selected. For example, the central wavelength may be selected in the following bands: 1200-1350 nm, 1500-1800 nm, 2000-2400 nm, which have low atmospheric and water absorption. One would understand that a low attenuation may be substantially comprised in the range of 5 to 20% of absorption.

Alternatively, if used spectral bands cover different regimes of eye-safety regulations, for example wavelengths below 1400 nm (more hazardous and having lower energy limits for eye-safety) and wavelengths above 1400 nm (less hazardous and having higher energy limits for eye-safety), the trigger pulse, which is an high energy containing pulse, is advantageous selected to be on the safer side of the limit. Namely, in this particular case, the trigger pulse is above 1400 nm in the spectral domain, whereas the majority of the pulses of the pulse-train are below 1400 nm in the spectral domain.

Thanks to these features, time domain methods could be used in the processing, which may need less processing time.

In general, the predefined rank may be any rank of the pulse-train. In embodiments, the predefined rank is the last rank, and the time-window ends after said trigger time. Alternatively, in embodiments, the predefined rank is the first rank, and the time-window starts from said trigger time.

In embodiments, the pulse train further comprises a signature pulse having another predefined rank, the trigger pulse and the signature pulse being separated by a defined delay, and the optical energy of the signature pulse is also higher than the optical energy of the majority of the pulses, and wherein the coarse detection step further comprises:
detecting a second overcome of the predefined amplitude threshold, at the defined delay from the trigger pulse,
   prior to perform the fine detection step. One can say that the ranks of the high intensity pulses forms a signature of the presence of the pulse train reflection. This could allow some crude material estimation, while reserving the finer material estimation (all pulses) for situation where the SNR is high.

In an embodiment, the number of higher energy pulses that are sent is determined based on a measured or based on an estimated SNR, with a higher number of higher energy pulses being sent if the SNR is high. Namely, the transceiver assembly is further configured to select a shape of the pulse-train, wherein the shape a trigger pulse is comprised between: a first shape, wherein the trigger pulse is a single pulse of the pulse-train which has an optical energy higher than the optical energy of the rest of the pulses, and a second shape, wherein the pulse train comprises both the trigger pulse and the signature pulse, wherein the transceiver assembly is further configured to select the second shape as a response of detecting that the SNR is higher than a predefined ratio threshold.

This allows an allocation of the total energy in multiple pulses when the SNR is high enough to allow a detection of lower energy pulses. However, when the SNR is very low, then fewer higher energy pulse (and only one high energy pulse) are sent. This allows for a concentration of the total energy in a single pulse to optimize the detection.

One would understand that a high SNR could be for instance a SNR higher than 5. Thanks to some features as described hereinabove, related to the pulse train, it is possible to sense targets thanks to the LiDAR device even for SRN values below 5, according to simulations. Algorithms like autocorrelation are fine with even lower values of SNR.

In embodiments, the rank of the signature pulse is the last rank.

In embodiments, the factor between the optical energy of the trigger pulse and the optical energy of the majority of the pulses is comprised between 2 and 10, preferably is substantially equal to 5.

In embodiments, the transceiver assembly comprises a laser emitting module configured to generate the incoming laser signal.

In addition, according to an embodiment, a Fiber Bragg Gratings (FBG) can be customized for central wavelength and bandwidth, wherein the first pulse is tuned to have higher bandwidth than other at a wavelength which propagates through atmosphere, having the following properties: eye safe and/or high reflectance on most surfaces.

For instance, the laser emitting module may comprise a broadband laser source, which is configured to generate an incoming broadband laser pulse, and a superstructure FBG,
wherein the superstructure FBG comprises a plurality of successive FBG portions, wherein each respective FBG portion is configured to reflect a respective pulse bandwidth centered on a respective different wavelength within the spectral range, wherein the superstructure FBG is configured to generate the pulse-train from the incoming broadband laser pulse.

In other words, the LiDAR device transforms an outgoing single pulse into a pulse-train, where each pulse in the train is at different wavelength. Thanks to these features, the returning light, or reflected light, can be detected and spectrally discriminated using a single detector and fast digitizer. In addition, detecting the distance using a pulse train will be more robust than with a single pulse using frequency domain-based methods. Indeed, using a pulse train improves the accuracy of distance measurement compared to single pulse when using frequency domain-based methods.

In an alternate embodiment, the superstructure fiber Bragg grating as described above may be arranged on the receiving side of the LiDAR device rather than on the emitting side of the LiDAR device as described above.

Using a superstructure FBG has many advantages, namely:
a single detector can be used.
one can get a higher SNR and a simpler system than by using array detectors,
every pulse carries spectral information, leading to a more robust spectral classification,
all (or part) of the optical components of the LiDAR may easily be fiber-coupled, instead of taking into account unpractical mechanical movements of optical components,
The manufacturing is scalable, thanks for instance to laser-machining the FBG structures,
The LiDAR is more robust in general.

Each grating may be formed by grating a periodic variation in the refractive index of the fiber core between a high refractive index and a low refractive index, which generates a wavelength-specific dielectric mirror.

There is a linear relationship between the respective different wavelength and the grating period: the reflected wavelength is equal to the grating period multiplied by the effective refractive index of the grating in the fiber core, multiplied by two. There also is a linear relationship between the reflected pulse bandwidth and the refractive index variation amplitude.

In embodiments, the FBG portion which is configured to reflect the trigger pulse has a periodic refractive index variation which has a bigger amplitude than periodic refractive index variations of the other FBG portions of the superstructure FBG, such that the pulse bandwidth of the trigger pulse is broader than the pulse bandwidth of the majority of the pulses.

In an embodiment, the optical detector is a broadband unique detector. For instance, the optical detector is a broadband unique sensor. Such a LiDAR device may combine the sensitivity and cost efficiency of a single detector multispectral LiDAR without losing spectral information to filtering.

In embodiments, the detection signal is an electrical detection signal.

In embodiments, the incoming broadband laser pulse is a supercontinuum (SC) broadband laser beam pulse having a pulse duration comprised between 0.5 ns and 5 ns.

The broadband laser source can be a solid-state laser source for instance.

In embodiments, the broadband laser source is not limited to a supercontinuum source. It could be any spectrally broadband light such as Raman lasers or frequency combs.

In embodiments, the broadband laser beam pulse is a supercontinuum (SC) broadband laser beam pulse having a pulse duration comprised between 0.5 ns and 5 ns. Indeed, shorter pulse duration would require a faster detection, which would be more expensive. A longer pulse duration would require a very long delay line, therefore the supercontinuum generation will be inefficient.

Preferably, the pulse duration is about 1 ns. Preferably, the SC bandwidth of the spectral range has a value comprised between 10 nm and 1000 nm. Indeed, the minimum SC bandwidth is 10 nm (when arranged for detecting only water/ice or a specific chemical/material) and the maximum is 1000 nm (when arranged for detecting whole Short-Wave Infrared—“SWIR”—region for best possible multitarget identification).

More preferably, the SC bandwidth has a value comprised between 200 nm and 300 nm. More preferably, the SC bandwidth has a value of 300 nm, and the broadband laser beam pulse has a spectral range comprised between 1000 nm and 1700 nm. For instance, a SC bandwidth of 300 nm (for the spectral range 1400-1700 nm) is an optimal for eye-safety and low-cost detection.

In general, a pulse within the pulse train has a filtered bandwidth which is the bandwidth of the spectral range of the broadband laser beam pulse divided by any number N, for instance R may be equal to 4 or 5 or any number higher, as for instance 20 or more.

Assuming a SC pulse duration of 1 ns, a time interval between two adjacent pulses of the pulse-train —which can also be referred to as a time separation of filtered pulses—may be comprised between 1 and 5 ns. One can generalize this ratio R (R being comprised between 1 and 5) between a SC pulse duration (dt), and a time interval as follows: the time interval between two pulses in the pulse train is equal to a duration or R*dt (Therefore the time interval is comprised between 1*dt and 5*dt).

Preferably, a pulse within the pulse train has a filtered bandwidth which is the bandwidth of the spectral range of the broadband laser beam pulse divided by 4 or 5. In other words, the bandwidth of a time-separated pulse of the pulse-train is optimally SC bandwidth divided by 4 or 5, thus for a SC bandwidth equal to 300 nm, a filtered bandwidth of 40-80 nm per pulse of the pulse-train is ideal.

The invention further provides a vehicle comprising a LiDAR device as described hereinabove.

In embodiments, the invention further provides a use of a LiDAR device as described hereinabove, in an application selected in the list consisting in automotive application, surveillance and/or security application, aviation application, windmill blade inspection application, such as monitoring of dirty and/or worn out blade covered by ice, and mining application such as for instance ore grade.

The invention further provides a multispectral LiDAR device, the device comprising,
an optical input for receiving a broadband laser beam pulse having a spectral range,
an optical transmitter configured for outputting the broadband laser beam pulse along a direction, the optical input and the optical transmitter being optically connected, and
an optical receiver configured to receive a reflection of the broadband laser beam pulse from said direction, and
an optical detector configured to detect a time-of-flight and an optical power of at least part of the reflection of the broadband laser beam pulse, wherein the optical detector is optically connected to the optical receiver, wherein the device further comprises:
a spectral delay unit configured for delaying the broadband laser beam pulse depending on the wavelength, to give a wavelength comb selected in the spectral range, such that the broadband laser beam pulse is transformed into a pulse-train wherein each pulse in the train is at a different wavelength of the wavelength comb.

Advantageously, the spectral delay unit is further configured such that a pulse of a predefined rank in the pulse-train has a higher intensity. Advantageously, the spectral delay unit is a superstructure FBG as described hereinabove.

The invention further provides a LiDAR device, comprising a transmitter assembly adapted to transmit an aperiodic pulse-train of successive pulses, and an optical detector configured to:
detect pulses from the aperiodic pulse-train of successive pulses, wherein each pulse has a rank in the pulse-train, and wherein a pulse having a defined rank is separated from the pulse of next rank above by a predefined time interval, wherein the predefined time interval is associated with the defined rank, such that the pulse-train form a series of predefined time intervals, wherein the predefined time interval is a predefined delay function of said rank,
detect a series of actual time intervals between detected pulses,
compare the series of actual time intervals to the series of predefined time intervals, in order to:
determine the rank of the detected pulses, and
determine a delay of reception of a detected pulse, which is the addition of a time-of-flight and a function of the time-interval associated to the determined rank of the detected pulse. One would understand that the time-of-flight is the natural travel-time of the light from the source to the detector, after reflection on a target, or an obstacle. One would understand that the time interval is introduced in addition to this time-of-flight.

One would understand that an aperiodic pulse train is a pulse-train wherein the time interval between each couple of adjacent pulses is not a constant. Such a LiDAR device makes it possible to determine without ambiguity which pulse is returned when some pulses are missing from the pulse-train.

A lot of different predefined delay function of the rank may be selected to implement the LiDAR device. Preferably, the predefined delay function is an exponential function of the rank.

Such a configuration can be advantageously applied to a multispectral LiDAR system, wherein each pulse has a different spectral characteristic.

Advantageously, the transmitter assembly is further configured such that a pulse of a predefined rank in the pulse-train has a higher intensity. Advantageously, the transmitter assembly comprises a superstructure FBG as described hereinabove.

### BRIEF DESCRIPTION OF THE DRAWINGS

Other features, details and advantages will be shown in the following detailed description and on the figures, on which:

FIG. 1 is a functional schematics of a spectral delay unit in temporal space and in spectral space.

FIG. 2 is a functional schematic of a superstructure FBG and of its functioning as a spectral delay unit on the spectral space.

FIG. 3 is an optical functional schematic of a multispectral LiDAR device according to a first embodiment, wherein a spectral delay unit comprising a superstructured FBG is arranged on the transmitter side.

FIG. 4 is a schematic of the FIG. 3 with illustrations of spectral space at the different step of propagation of an initial broadband pulse.

FIG. 5 is an optical functional schematic view of a multispectral LiDAR device according to a second embodiment, wherein a spectral delay line comprising a superstructured FBG is also arranged on the transmitter side, but the detection on the receiver side is performed in free optical space.

FIG. 6 is an optical functional schematic view of a multispectral LiDAR device according to a third embodiment, wherein a spectral delay line comprising a superstructured FBG is arranged on the receiver side.

FIG. 7 is an optical functional schematic view of a multispectral LiDAR device according to a fourth embodiment.

FIG. 8 is an optical functional schematic view of a multispectral LiDAR device according to a fifth embodiment.

FIG. 9 is a schematic of a spectral delay unit according to a variant, which comprises a tunable filter.

FIG. 10 is a schematic of a spectral delay unit according to another variant, which operates on free optical space.

FIG. 11 is an illustration of a free-space alternative to the use of a spectral delay unit.

FIG. 12 represents a simulation of a signal of generated pulse-train.

FIG. 13 represents a simulation of a signal of generated pulse-train with variable time interval values between successive pulses.

FIG. 14 represents simulations of transmitted and returned pulses over the time.

FIG. 15 represents histograms of error in measuring the time of flight of the pulses at several SNR values, using single pulse and pulse train.

FIG. 16 represents graphs of the simulation of different characteristics of the signal of a single pulse.

FIG. 17 represents graphs of the simulation of different characteristics of the signal of a pulse-train.

FIG. 18 represents a schematic of a received periodic pulse-train wherein pulses are missing.

FIG. 19 represents a LiDAR device configured to get an improved SNR for distance measurements.

FIG. 20 represents a processing module of the LiDAR device of FIG. 18.

FIG. 21 represents a digital acquisition of the power over the time of an incoming pulse-train and its reflected counterpart, when the incoming pulse-train is designed to present a high intensity first pulse.

FIG. 22 represents a digital acquisition of the power over the time of an incoming pulse-train and its reflected counterpart, when the incoming pulse-train is designed to present a high intensity second pulse.

FIG. 23 represents a digital acquisition of the power over the time of an incoming pulse-train and its reflected counterpart, when the incoming pulse-train is designed to present a high intensity last pulse.

### DESCRIPTION OF THE PREFERRED EMBODIMENTS

Figures and the following detailed description contain, essentially, some exact elements.

They can be used to enhance understanding the invention and, also, to define the invention if necessary.

For the sake of conciseness, the elements which are similar or equivalent through the description will be described with reference to the same reference numbers.

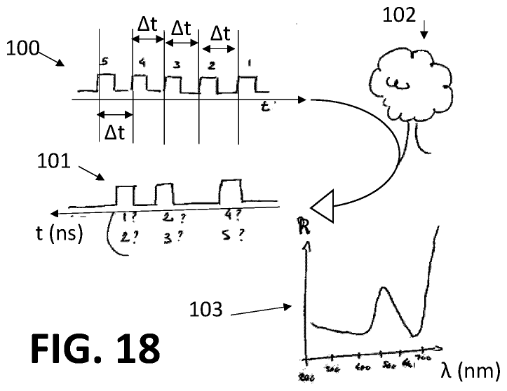

FIG. 18 represents the delay incertitude on a ToF of a pulse-train in a low SNR situation. As one can see, a transmitted pulse-train 100 comprises pulses ranked from 1 to 5, represented on a time axis and steered on an obstacle 102 (pictured by a tree). Each pulse is a wavelength channel for information. The reflection of the transmitted pulse-train 100 is the reflected pulse-train 101.

One can see on the schematics that two pulses are missing from the reflected pulse-train 101 (because of absorption by the obstacle 102). For instance, when each pulse has a different wavelength λₖ of rank k within a spectral range, some pulses are absorbed by the obstacle 102 as a function of the spectral absorption of the obstacle 102. As one can see on the drawn schematic graph 103, the missing pulses are due to spectral absorption by the obstacle 102, which is noticeable on the pictured reflected spectrum R of the pulse-train 100 which corresponds to the reflected pulse-train 101.

These missing pulses in a periodic pulse-train create an ambiguity on the reception side: which pulses are missing? In the current example, two options should be contemplated: either the pulses ranked 1 and 4 are missing, or the pulses ranked 3 and 5 are missing.

In order to avoid occurrences of such ambiguities, one can introduce a high intensity trigger pulse.

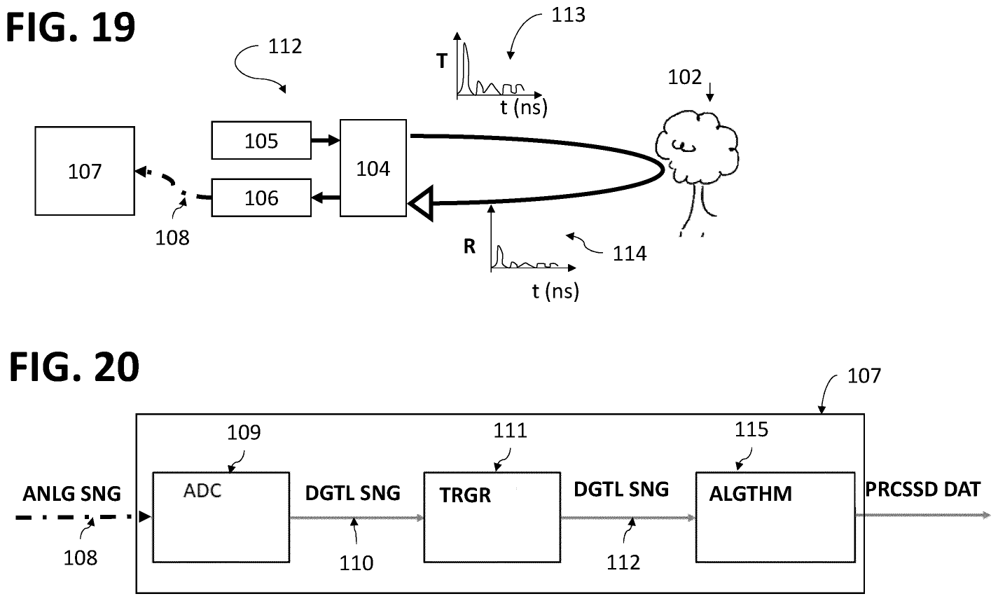

FIG. 19 schematically represents a laser detection and ranging (LiDAR) device 112, configured to get an improved signal-noise ratio (SNR) for distance measurements.

The LiDAR device 112 comprises a laser source module 105, an optical transceiver 104 and an optical detector 106.

The laser source module 105 is configured to emit an incoming laser signal comprising an incoming pulse-train 113. The travel of light is represented by solid-line arrows.

The optical transceiver 104 is configured to transmit the incoming pulse-train 113 on a target 102. The incoming pulse-train 113 is reflected by the target 102. The optical transmitter 104 is further configured to receive a reflected pulse-train 114 which is at least part of the reflection and/or backscattering of the incoming pulse-train 113 on the target 102.

The optical detector 106 of the LiDAR device 112 is configured to receive the reflected pulse-train 114 from the optical transceiver 104, and to convert the optical signal corresponding to the reflected pulse-train 114 into an electrical analogical signal 108, which is represented by a dashed-line arrow.

The LiDAR device 112 further comprises a processing module 107 connected to the optical detector 106 for receiving and processing the electrical analogical signal 108, as it is further explained with reference to FIG. 20.

FIG. 20 schematically represents the processing module 107. The processing module 107 comprises a converter module 109 which is configured to convert the analogical signal 108 into a digital signal 110.

The processing module 107 further comprises a triggering module 111 configured to detect that the digital signal 110 overcomes a signal threshold. The triggering module 111 is further configured to identify a time-position of the reflected pulse-train 114 within the digital signal 110 in response to the detection.

In other words, the triggering module 111 is adapted to perform a coarse detection step.

The processing module 107 further comprises a calculation module 115 configured to receives a triggering signal 112 from the triggering module 111. Said triggering signal 112 comprises the time position.

The calculation module 115 is further configured to identify pulses of reflected pulse-train 114 in response to receiving said triggering signal 112, and to recover a timestamp and an energy value for each identified reflected pulse,

In other words, the calculation module 115 is adapted to perform a fine detection step.

The calculation module 115 is further configured to recover a timestamp and an energy value for each emitted pulse of the incoming pulse-train 113. The calculation module 115 is further configured calculate a time-of-flight (ToF) and an attenuation for each identified reflected pulse. The ToF is calculated as a difference between the timestamps of an emitted pulse and its reflected counterpart. The attenuation is calculated as a difference between the energy value of an emitted pulse and its reflected counterpart.

Therefore, one can identify a distance from the LiDAR device 112 to the target 102 thanks to the calculated ToF. One can further identify a material composition of the target 102, thanks to spectral characteristics derivable from the calculated attenuation.

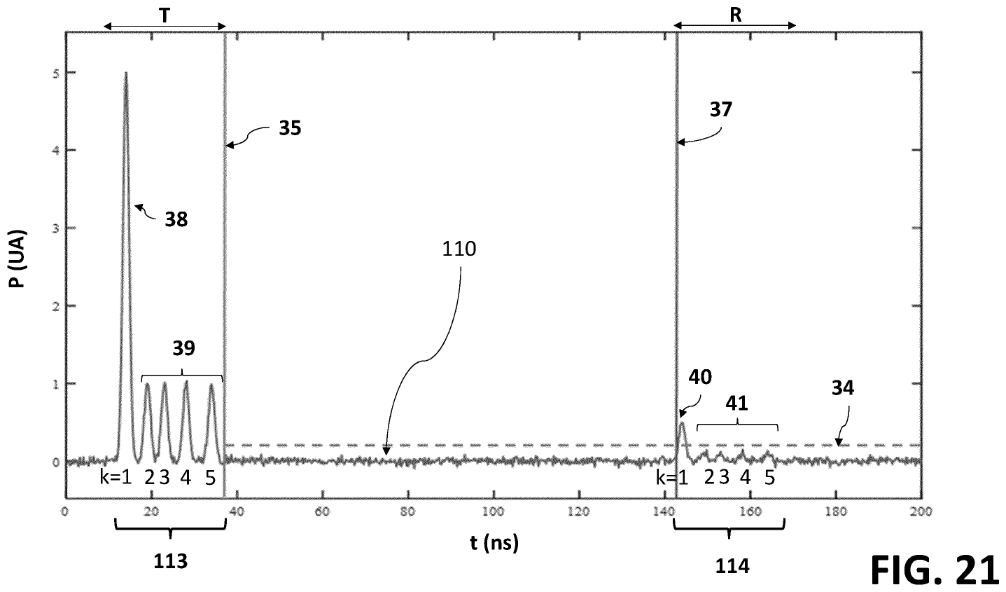

The triggering and/or the calculation performed by the triggering module 111 and/or the calculation module 115 are illustrated on the example of a digital signal 110 according to a first arrangement of an incoming pulse-train 113, with reference to FIG. 21.

FIG. 21 represents the digital acquisition of the power (arbitrary unit) over the time of an incoming pulse-train 113 comprising five pulses ranked from k=1 to k=5, and a corresponding reflected pulse-train 114 comprising same attenuated pulses. The attenuation comes from the absorption characteristics of the atmosphere and of the target 102.

As one can see, the first pulse (i.e. ranked k=1) of the incoming pulse-train 113 is generated to have a higher energy value than the other pulses 39 of the incoming pulse-train 113. Namely, the magnitude of the peak power of said first pulse is five times the magnitude of each of the other pulses 39. Said first pulse may be referred to as a trigger pulse 38.

A monitoring phase is triggered at the end 35 of the emission of the incoming pulse-train 113. The end 35 corresponds to the shortest measurable distance without interference from the incoming laser signal. During the monitoring phase, the triggering module 111 is active. Before the end 35, the triggering module 111 may be set inactive.

When active, the triggering module 111 monitors the digital signal 110 in order to detect any overcome of a predefined signal threshold 34.

As one can see on FIG. 21, an overcome occurs at a trigger time 37, corresponding to the reflection of the trigger pulse 38. The triggering module 111 detects said trigger time 37 and is triggered to transmit the triggering signal 112 to the calculation module 115.

Starting from the trigger time 37, the calculation module 115 then identifies the reflected pulse-train 114 within a time-window. One can see the pulses of the reflected pulse-train 114: a high intensity pulse 40, and the rest of the pulses 41. One can see that the rest of the pulses are below the signal threshold 34.

For instance, the time-window duration can be substantially set to the duration of emission of the pulse-train 113 from the first pulse to the last pulse. Ideally, one would add to the duration of emission a supplementary duration corresponding to the time spreading of the pulse-train 113.

Therefore, the time-window extends from the trigger time 37 to a closing time, which is later to the trigger time 37 from the time-window duration.

The calculation module 115 identifies the ranks of the pulses of the reflected pulse-train 114, as indicated on FIG. 21 from k=1 to 5. The calculation module 115 further associates a timestamp and an energy value of each pulse of the reflected pulse-train 114 to the corresponding rank.

One recognizes in the reflected pulse-train 114 the counterpart 40 of the trigger pulse 38, and the counterpart 41 of the other pulses 39.

For example, the ToF and attenuation are then calculated rank by rank, from each reflected pulse, by comparison with the corresponding incoming pulse of same rank. Thanks to the trigger pulse 38 of high energy, a long-range detection is possible even in low SNR situation.

Namely, a time separation between the end 35 of the emission of the incoming pulse-train 113 and the trigger time 37 may typically be in order of 3 ns to 3000 ns.

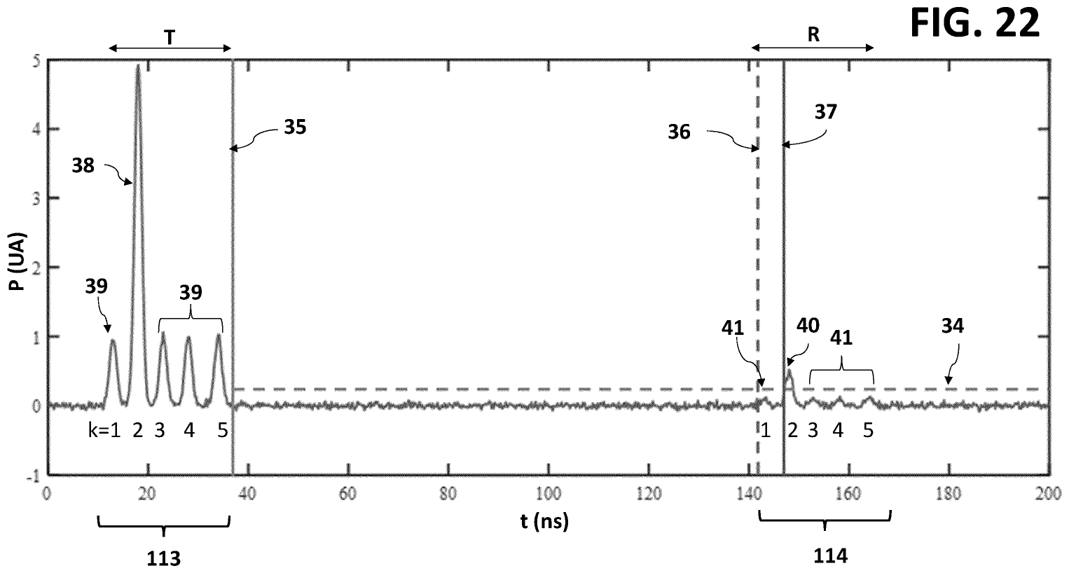

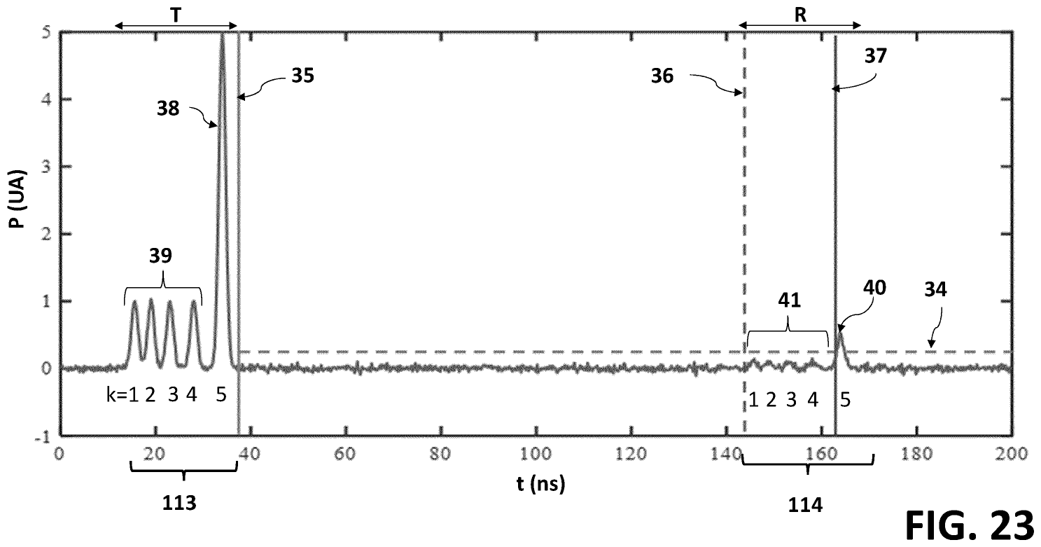

FIG. 22 and FIG. 23 represent two exemplary variations of the shape of the pulse-train 113, wherein the high intensity pulse is not the first pulse of the pulse train 113, but respectively the second pulse and the last pulse.

Everything that has been presented above with reference to FIG. 21 is similarly applicable to both cases, with the simple difference that the time-window is shifted with reference to the trigger time 37.

Indeed, when the incoming pulse-train 113 is designed to present a high intensity second pulse, the time-window is configured to be shifted compared to the trigger time 37, by a time shift corresponding to a time interval between the first and the second pulses of the pulse-train 113.

Indeed, when the incoming pulse-train 113 is designed to present a high intensity last pulse, the time-window is configured to be shifted compared to the trigger time 37, by a time shift corresponding to a number N−1 of time intervals between the pulses ranked from k=1 to N.

Regarding the data stream within the processing module 107 represented on FIG. 20, it is possible to implement autocorrelation or similar algorithm by the calculation module 115, on the whole detected Tx-Rx trace. One would understand by the wording “Tx-Rx trace” the optical power over the time at the transmitting stage (Tx) as well as at the receiving stage (Rx). It is such a Tx-Rx trace which is represented by the digital signal 110 on FIG. 21, respectively on FIG. 22 or FIG. 23.

When emitting successive pulse-trains, for instance periodically, one can identify a pulse-train within a train of pulse-trains by a train rank. The whole Tx-Rx trace corresponds to a time-window between a beginning of the Nth transmitted pulse-train and an end of the (N+1)th pulse-train, where trigger is applied after the algorithm.

Generation of a Train-Pulse Having a High Intensity Pulse of Rank k:

One can generate a trigger pulse 38 in different manners. In general, the intensity of the trigger pulse 113 can be stronger because of setting:
a higher level of energy at the particular wavelength of the trigger pulse 113, and/or
a broader bandwidth (i.e. range of wavelengths) in the trigger pulse 113.

For example, in order to shape a trigger pulse 38 to have a higher optical energy as the majority of pulses 39, one can for instance advantageously set the bandwidth of the trigger pulse 38 to be broader than the bandwidth of each of the majority of the pulses 39.

For instance, in order to generate a pulse-train with such a trigger pulse 38, one can use a superstructured fiber Bragg grating (FBG) as described below, inputted by an emitted laser beam pulse 1 having a spectral range 2.

In such an example, the LiDAR device may be configured to transform the emitted broadband laser beam pulse 1 into the pulse-train 113.

Spectral Delaying of a Broadband Pulse

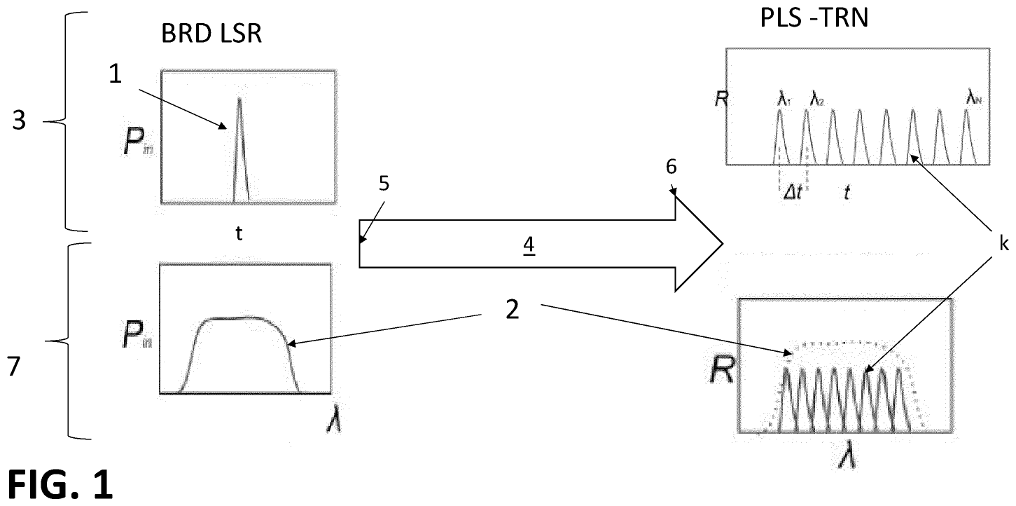

Such a LiDAR may comprise a spectral delay unit 4 as represented on FIG. 1.

One can see on the left side of FIG. 1 a representation, in the temporal space 3, of the emitted broadband laser beam pulse 1. As represented in the spectral space 7, the emitted broadband laser beam pulse 1 has a spectral range 2.

The emitted broadband laser beam pulse 1 is introduced inside the spectral delay unit 4 through a delay input 5.

The spectral delay unit 4 is configured for delaying the emitted broadband laser beam pulse 1 as a function of the wavelength, within a wavelength comb selected in the spectral range 2. Such a wavelength comb is represented (in the spectral space 7) on the right side of FIG. 1.

Therefore, the broadband laser beam pulse 1 is transformed by the spectral delay unit 4 into a pulse-train wherein each pulse in the train is at a different wavelength of the wavelength comb. The pulse-train is represented (in the temporal space 3) on the right side of FIG. 1.

The pulse-train is then transmitted through a delay output 6 of the spectral delay unit 4.

In the example, the number of pulses of the pulse train, i.e. of wavelength channels, is N=8 channels. Each pulse has a rank k, where k is selected from 1 to N=8.

The pulse of rank k is delayed from the pulse of previous rank from the time interval Δt (which can also be written as: “DELTA_t”). The time interval Δt may a constant or not.

The pulse of rank k is filtered to correspond to the wavelength λₖ (which can also be written as: “lambda_k”).

As an example, the number of channels represented on FIG. 1 is N=8, but any other number N of channels may be provided in general.

Superstructure Fiber Bragg Gratings

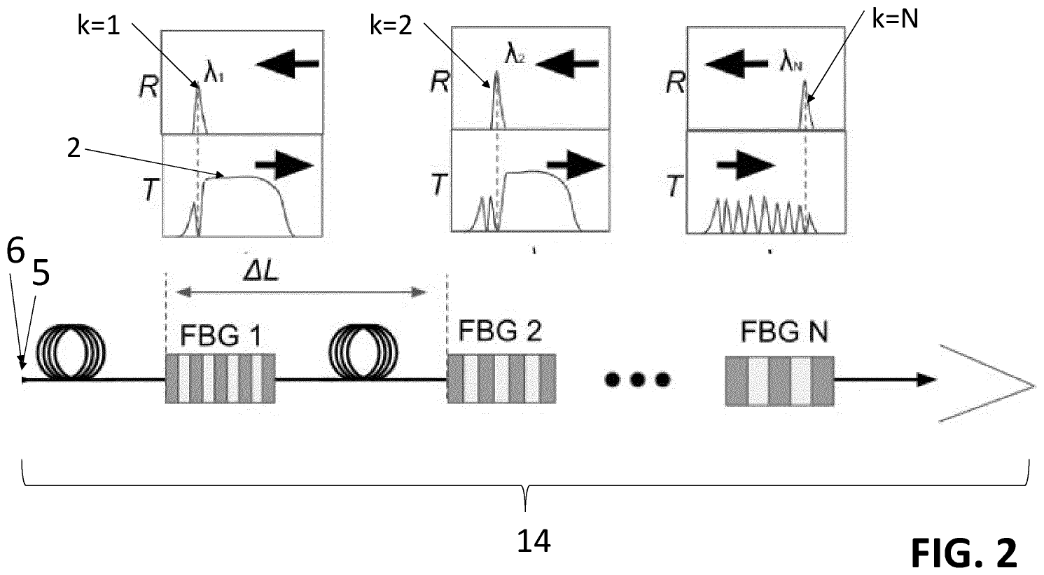

In an advantageous embodiment of the disclosure, the spectral delay unit 4 is an optical fiber of kind superstructured fiber Bragg grating (FBG) 14, as represented on FIG. 2. The superstructured FBG 14 is formed by an optical fiber which is grated by a series of successive ranked FBG of rank k. A FBG is spaced from the FBG of next rank above by a space interval ΔL (which can also be written as: “DELTA_L”). The space interval ΔL may be a constant or not.

On FIG. 2, and above each corresponding representation of FBG of rank k, a spectrum T of the transmitted light and a spectrum R of the reflected light are represented. The arrows represent the direction of propagation of the light: transmitted from left to right, and reflected from right to left.

As one can see, each FBG of rank k is tuned for a different wavelength λₖ, such as to reflect a narrow spectral band of light centered on the wavelength λₖ within the spectral range 2. On the example of the FIG. 2, only the gratings of the rank k=1, rank k=2 and rank k=N are represented.

At each FBG of rank k, only a pulse of rank k is reflected, and the rest of the light is transmitted to the FBG of next rank.

Therefore, the reflected narrowband light pulses will be separated in time, due to the time it takes for light to travel twice the distance between successive FBGs. Namely, the time interval Δt between two successive pulses is equal to twice the space interval ΔL, multiplied by n/c, wherein n is the index of the optical fiber, and c is the speed of the light in void. For instance, with an index of n=1.5 and a space interval ΔL equal to 30 cm, one gets a time interval Δt equal to 3 ns.

Thus, the initial broadband laser beam pulse 1 is divided into the series of narrowband light pulses. This is advantageous because it allows spectral discrimination by resolving the pulses with a single fast detector.

Preferably, but optionally, the FBGs are arranged as on FIG. 2, i.e. such that the selected wavelength λₖ of a pulse of rank k is an available wavelength of the wavelength comb next to the pulse of immediate previous rank.

One can design the FBG of the predefined rank of the trigger pulse 38 to have a larger difference between the two alternate refraction indexes than the other FBG of the superstructured FBG 14. Because of the relationship between the difference of indexes and the bandwidth of the reflected narrowband pulse, the bandwidth of said trigger pulse 113 is broader as the narrow bandwidth of the other pulses.

Therefore, starting from a supercontinuum broadband laser pulse 2, the total energy of the said trigger pulse 38 is higher.

In this embodiment, the delay input 5 and the delay output 6 of the are the very same end of the superstructured FBG 14 optical fiber.

Examples of LiDAR Devices with a Superstructure FBG

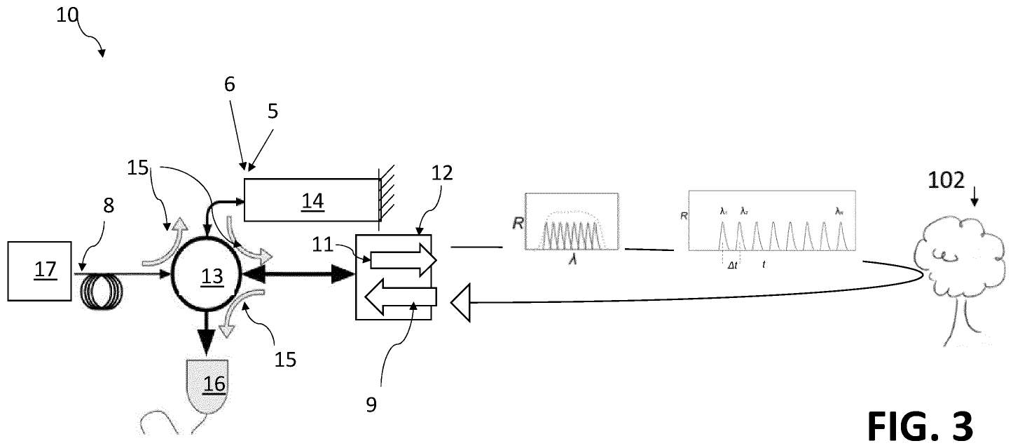

As represented on FIGS. 3 to 8, it is provided examples of multispectral LiDAR devices taking advantage of the above-described superstructured FBG 14.

Each represented multispectral LiDAR device comprises:
a supercontinuum laser source 17 for emitting the broadband laser beam pulse 1 into an optical input 8 of the LiDAR device,
an optical transmitter 11 configured for outputting light on an obstacle 102 to detect, and
an optical receiver 9 configured to receive a reflection of the outputted light from the obstacle 102, and
an optical detector 16 configured to detect a time-of-flight and an optical power of the reflection,
an superstructured FBG 14 line for transforming the broadband laser beam pulse 1 into the pulse-train as explained with reference to FIGS. 1 and 2,
an optical circulator 13 having at least two ports in order to connect at least some of the previous elements through optical fiber.

More specifically, on FIG. 3, the superstructured FBG 14 line is arranged on the emitting side of the represented multispectral LiDAR device 10.

A first port of the optical circulator 13 is fiber-coupled with the optical input 8, a second port is fiber-coupled to the superstructured FBG 14 line, the third port is fiber-coupled with a scanning module 12, and the fourth port is fiber-coupled with the optical detector 16. The arrows 15 represent the propagation of light inside the optical circulator 13.

The scanning module 12 comprises both the optical transmitter 11 and the optical receiver 9.

Advantageously, introducing the delays in the signal prior that the signal arrives to the scanning module 12 for scanning the obstacle 102 is practical, because the supercontinuum laser source 17 is already emitting inside an optical fiber.

For instance, the supercontinuum laser source 17 can be a solid-state laser source.

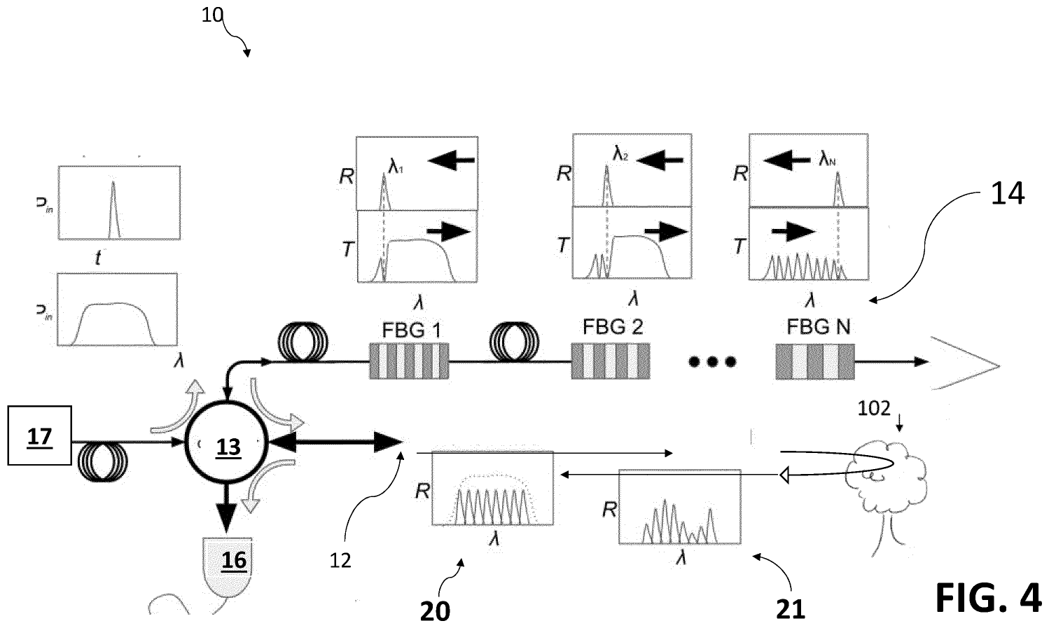

FIG. 4 represents the same multispectral LiDAR device 10 as FIG. 3, additionally to the spectrum of the light at each step of the propagation from the supercontinuum source 17.

The spectrum 20 is a schematic of the train of monochromatic pulses generated and emitted by the multispectral LiDAR device 10 at the output of the scanning module 12. The spectrum 21 is a schematic of the reflected train of monochromatic pulses received by the multispectral LiDAR device 10.

Namely, one can compare the spectrum 20 of the pulse-train to the spectrum 21 of the pulse-train reflected by the obstacle 102: depending on the wavelength channel, the light of the corresponding pulse is more or less absorbed by the obstacle 102.

The optical detector 19 receives the reflected train of pulses and distinctly detects an optical power for each peak, therefore for each wavelength. Therefore, the single optical detector 19 enables acquiring spectral information about the obstacle 102.

For instance, the optical detector 19 is a single sensor comprising an avalanche photodiode (APD) electrically connected to a digitizer having a sample rate of 3 GS/s, and to Field Programmable Gate Arrays (FPGA).

Some computation may be programmed to recover the time-of-flight of a pulse (for instance a monochromatic pulse), and thus the distance of a part of the obstacle 102 which is reflective to the pulse (for instance the monochromatic pulse). For instance, the computation comprises Fast Fourier Transform (FFT) based cross correlation.

The amplitude of the optical power of each detected peak is compared with the spectrum of the emitted broadband laser pulse.

This step may require multiple stages and a demultiplexer. For instance, in a 1st stage, one can use a fast transimpedance amplifier, and in further stages, a demultiplexer into N slower (integrating) amplifiers.

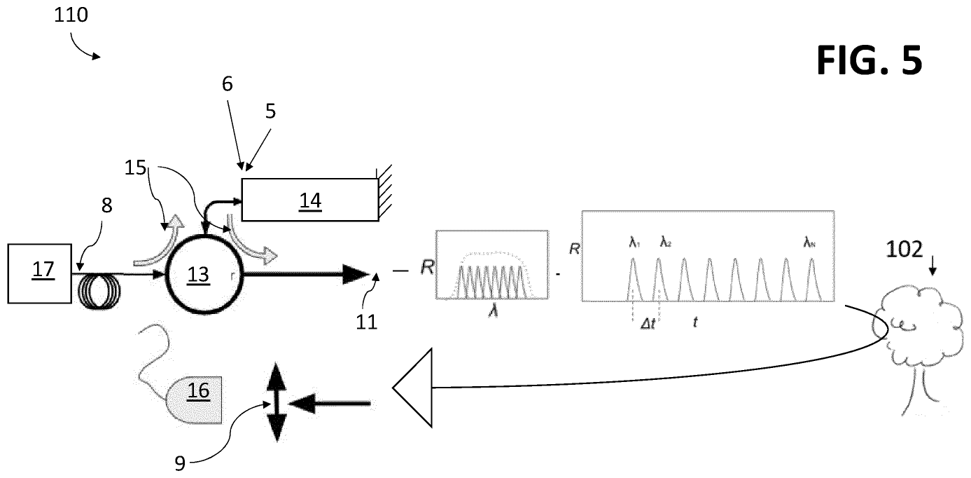

In a variant represented on FIG. 5, the superstructured FBG 14 line is also arranged on the emitting side of the represented multispectral LiDAR device 10, for the same advantages as already stated.

A difference with the multispectral LiDAR device 10 of FIG. 3 is that the third port of the optical circulator 13 is directly fiber-coupled to the optical transmitter 11. In this embodiment, the optical receiver 9 may be a free optical space lens which focus the received light onto the optical detector 16.

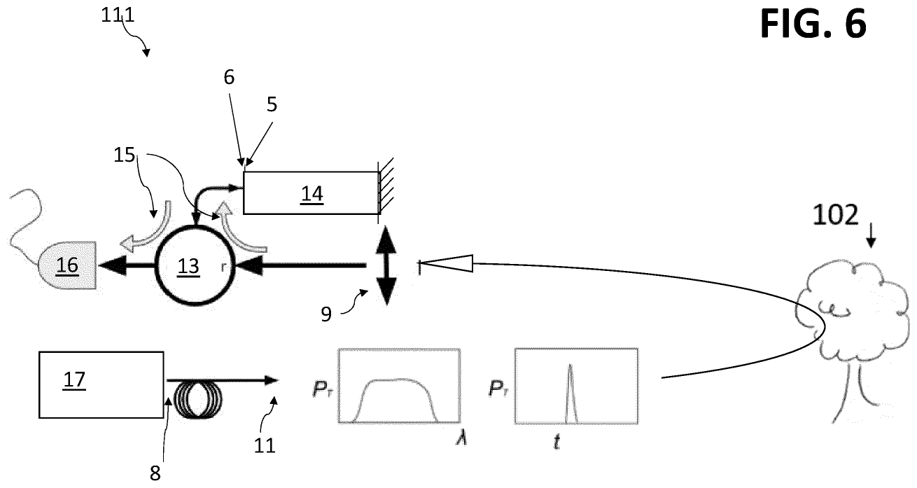

In a variant represented on FIG. 6, by contrast with the two examples of multispectral LiDAR devices above-described, the superstructured FBG 14 line is arranged on the receiving side of the represented multispectral LiDAR device 111. Introducing the delays on the receiver side is equivalent from an optics perspective, since the delays are introduced by passive components.

Hence, a difference with the multispectral LiDAR device 10 of FIG. 3 is that the optical transmitter 11 directly project the light from the supercontinuum laser source 17 on the obstacle 102. In such a configuration, the supercontinuum laser source 17 is not fiber-coupled to the optical circulator 13 but instead, directly fiber-coupled to the optical transmitter 11.

In this embodiment, the optical receiver 9 may be a free optical space lens which focus the received light inside an optical fiber which is fiber-coupled to a first port of the optical circulator 13. The second port is fiber-coupled to the superstructured FBG 14 and the third port is fiber-coupled to the optical detector 16.

In general, the optical transmitter 11 or the optical receiver 9 may be either fiber coupled or operating in free space. Detection can be either in bi-static or monostatic configuration.

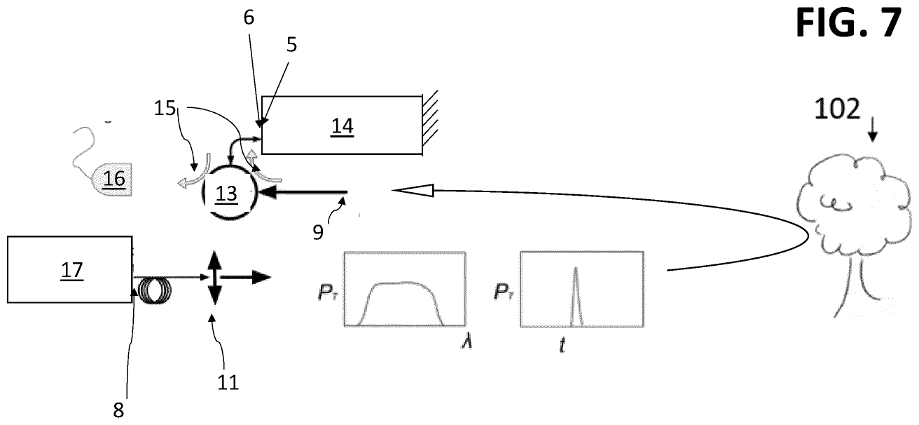

In a variant represented on FIG. 7, some other modifications have been brought to the arrangement of the LiDAR device 111 of FIG. 6. Namely, instead of the optical receiver 9, it is the optical transmitter 11 which may be a free optical space lens. Further, the optical detector 16 also operates on free space.

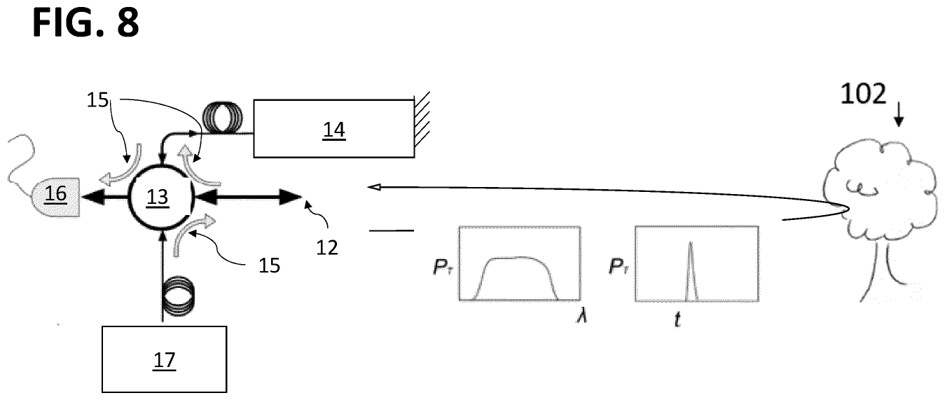

In a variant represented on FIG. 8, some modifications have been brought to the arrangement of the LiDAR device 10 of FIG. 3. Namely, the second port is fiber-coupled to the scanning module 12 and the third port is fiber-coupled with the superstructured FBG 14 line, which is the permuted configuration as on FIG. 3.

For the sake of comprehension, the spectrum and temporal envelope of the signal transmitted on the obstacle 102 is schematized on the FIGS. 3 to 8, in order to make it clear when the signal transmitted on the obstacle 102 is the initial broadband laser pulse 1 or the pulse-train.

In a variant, in the examples depicted on FIGS. 3 to 8, the use of the circulator 13 can be avoided by using dichroic/bandpass filter instead.

The various LiDAR devices above described enable the returning light to be detected and spectrally discriminated using a single optical detector 16 and fast digitizer. In addition, detecting the distance using a pulse train will be more robust than with a single pulse using frequency domain-based methods.

Variants of Spectral Delay Unit 4

In the description hereinabove, the spectral delay unit 4 was a superstructure FBG 14. In general, other technologies may be employed to obtain the result of both spatially and spectrally divide a single incoming broadband pulse. Similarly to the various LiDAR devices above described, said technologies may be provided either on the transmitter side or on the receiver side of the LiDAR devices.

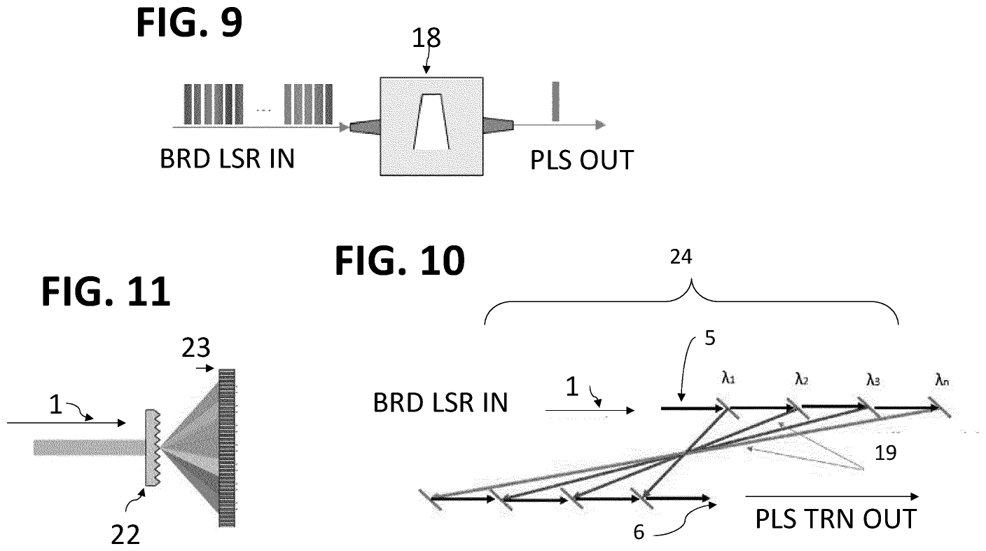

For instance, the spectral delay unit 4 may comprise a spectral bandpass filter such as the tunable filter 18, as represented on FIG. 9. The broadband incoming light at the left is filtered to get a wavelength-specific pulse at the right of the Figure. The tunable filter 18 may be tuned to a successive wavelength after each time interval, in order to produce the pulse-train.

The tunable filter 18 may be arranged either to transform the light transmitted to the obstacle 102 into a pulse-train, or to transform the light received from the obstacle 102.

Advantageously, a single detector can be used, which leads to a simpler system, and enables a higher Signal/Noise Ratio (SNR) than filtering the light through an array. Moreover, the tunable filter 18 is easy to optically align on the optical axis (namely when fiber-coupled).

One can remark that, compared to a tunable filter 18, the superstructure FBG 14 is advantageous. Indeed, the superstructure FBG 14 does not require to operate mechanical movements and enable to increase the number of spectral channels per supercontinuum pulse from 1 spectral channel to any number N.

For instance, the spectral delay unit 4 may be a free-space spectral delay line 24. In general, a free-space spectral delay line 24 may include a supercontinuum source, a set of filters which divide the beam into different paths each at different wavelength range and having different path length, and a beam combiner.

An example of free-space spectral delay line 24 is represented on FIG. 10. The broadband incoming laser pulse 1 is transmitted through successive notch filters of rank k, which are each configured to transmit all but a different specific wavelength. The part of the pulse which is not transmitted is reflected to a specific direction by a wavelength-specific mirror in free optical space, then re-directed to a unique direction by use of another mirror, such that all the wavelength channels are re-collected and transmitted to the single direction.

Thanks to this configuration, one can get different path lengths 19, which cause delays between spectral channels. At the delay output 6, the outgoing pulses each have a wavelength separated in time, without the use of an optical circulator 13.

For the sake of comparison, FIG. 11 illustrates an alternative to the use of a spectral delay unit 4. In this alternative, in order to spatially discriminate the wavelength channels, no delay is introduced. Instead, the reflected broadband laser pulse 1 is transmitted in optical free space to a dispersive element 22, such as a grating or a prism. The dispersed light is detected to an array of detectors 23, each detector being dedicated to a wavelength which is deviated to it by dispersion.

The spectral delay unit 4 is very advantageous compared to this alternative. For instance, the spectral delay unit 4 is less complex because it only requires a single detector. Moreover, array detectors generally have a factor of 10 lower SNR than corresponding single detectors. Array detectors multiply the costs compared to a single detector. Further, components in array detectors may be fragile compared for instance to a superstructure FBG 14.

Simulation Results

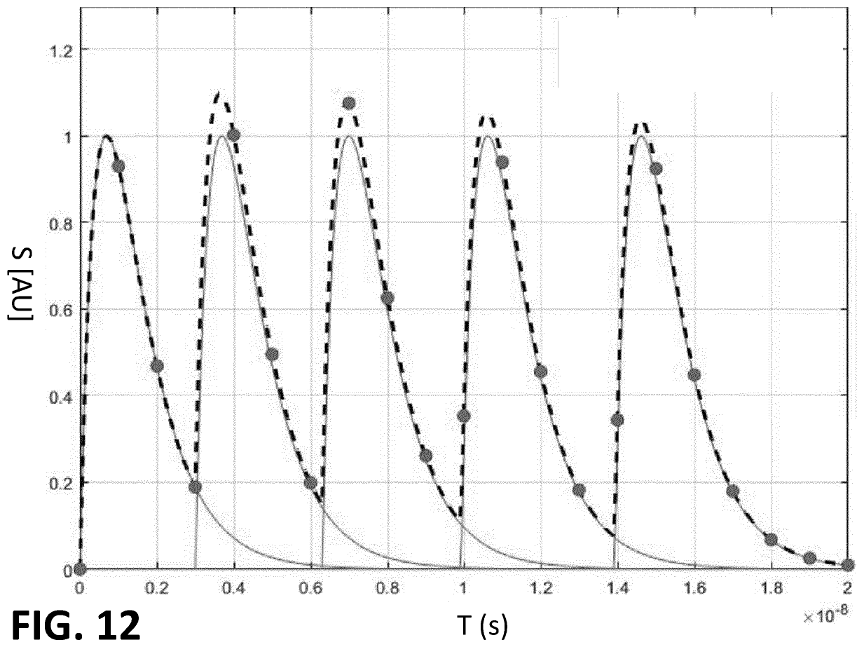

For documentary references, and with reference to FIGS. 12 to 17, there is provided some simulation results demonstrating various advantages and feasibility of a multispectral LiDAR operating with a spectral delay unit 4.

FIG. 12 represents a simulation of a signal S (arbitrary unit) over the time T (s). The plain line represents the ADP response to single pulses. The round markers represent the digitized signal. The dotted line represents the envelope.

The simulated pulse-train and single pulse where generated with the following hypothesis: the APD bandwidth is 1 GHz, the digitizer sampling rate is 1 GS/s, the delay between the 1st and the 2nd spectral channel is 3 ns, and each successive time interval is 10% longer than previous. For single pulse the first pulse of the train was used.

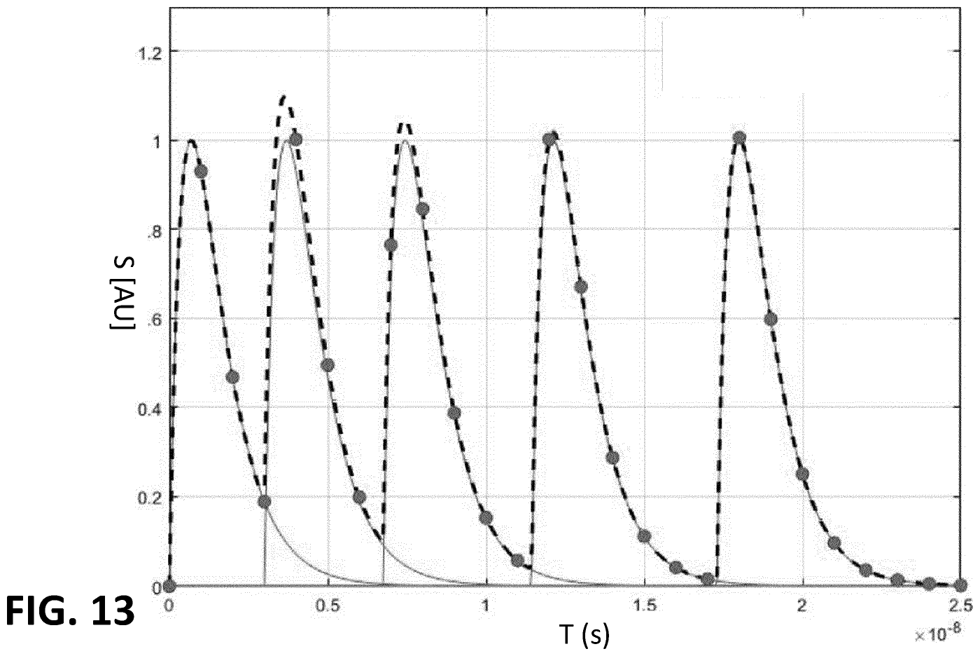

FIG. 13 represents another simulation of the signal S (arbitrary unit) over the time T (s). One can see that the results improve when increasing the successive time intervals between successive pulses in the train from 10% to 25%.

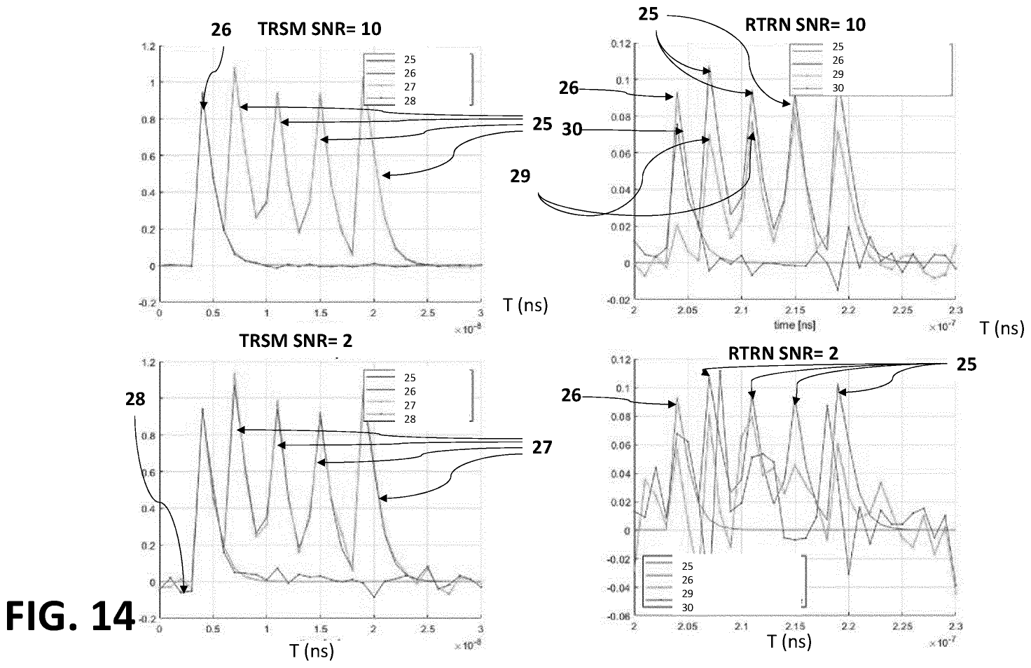

FIG. 14 represents simulations of transmitted and returned pulses over the time T (ns).

On the left, the simulations correspond to transmitted signals. There is printed for reference an ideal pulse train 25, and ideal single pulse 26. There is also printed simulations of a noisy pulse train 27, and of a noisy single pulse 28. The simulation above is performed with assumption that the SNR is equal to 10, whereas the simulation below is performed with assumption that the SNR is equal to 2. One can see that even with a lower SNR (SNR=2), the noisy single pulse 28, respectively the noisy pulse train 27, are almost perfectly superposed to the ideal pulse train 25, respectively ideal single pulse 26.

On the right, the simulations correspond to returned signals corresponding to the simulated transmitted signals: the simulation above is performed with assumption that the SNR is equal to 10, whereas the simulation below is performed with assumption that the SNR is equal to 2.

In addition to the ideal pulse train 25, and ideal single pulse 26, there are printed simulation of noisy reflected weighted pulse train 29 and noisy reflected weighted pulse train 30.

For a SNR equal to 10, the simulated noisy reflected pulses are corresponding to the temporal position of their simulated ideal counterparts, and the power peak is well defined for each of them.

By comparison, for a lower SNR, equal of 2, the simulated noisy reflected weighted pulse train 29 is more difficult to interpret as different well-defined peaks.

The simulation hereinabove described have been performed under the following assumptions: a random gaussian noise is added to the spectrum with standard deviation of expected pulse amplitude/SNR, for the expected pulse amplitude: each pulse is weighed by a random reflectance value between 0.10 and 0.9 with the expected value of 0.5. For each SNR and pulse type (train vs single) combo, 10 000 simulated traces were generated.

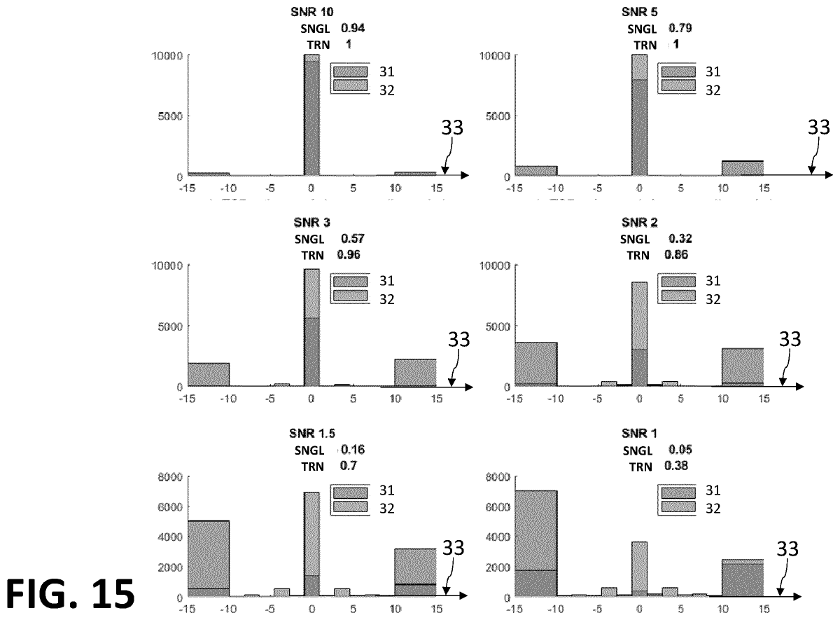

FIG. 15 represents histograms of error in measuring the time of flight of the pulses at several SNR values, using single pulse and pulse train. The histogram represents repartitions on an axis 33 of error in the time-of-flight (TOF) estimate relative to sampling period. Below the value of the SNR on each histogram, a first value represents the Nitrate of single pulse, above a second value which represents the Nitrate of the pulse-train. The assumptions made are following:
Unit—sampling period (1 ns in this case).
The time of flight estimate is always more accurate with pulse train.

At SNR<5 errors corresponding to integer times the delay in the spectral channels can be seen. Most likely the performance can be optimized by modifying the spectral channel delays and/or increasing sampling rate.

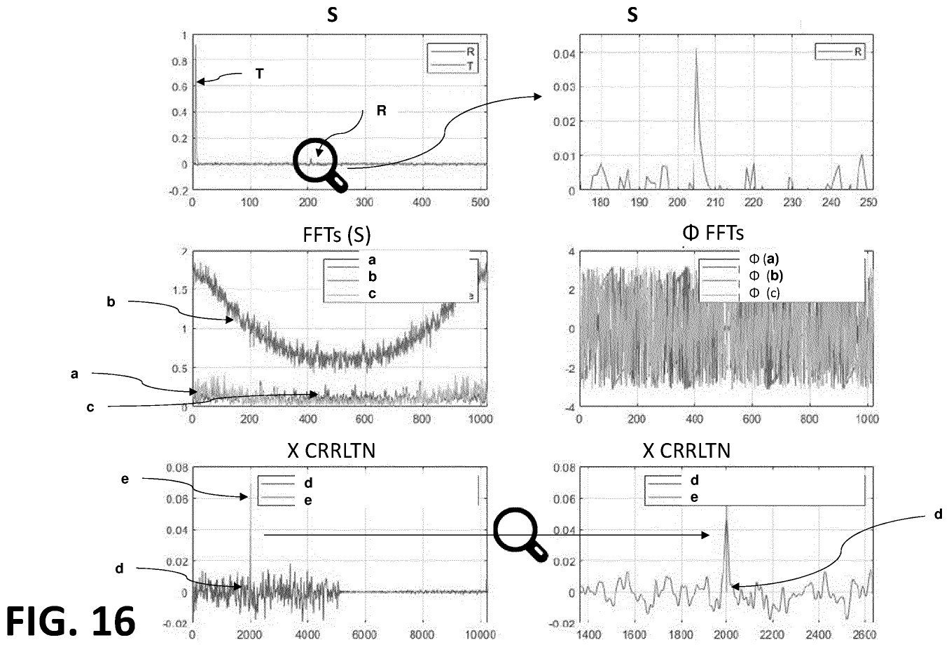

FIG. 16 represents graphs of the simulation of the signals S of a single pulse:
transmitted signal T and reflected signal R,
FFTs of the signal S: absolute values of a—FFT(R, n), b—conj [FFT(T, n)], and c—the product of the above,
the phase ϕ (which can also be written: “PHI”) of the above FFTs, and
the Cross correlation X: d—real part of the ifft of the product above; e—max.

The assumption is a SNR=10. Zooms on the graphs are represented, which are indicated by a magnifying glass icon and arrows.

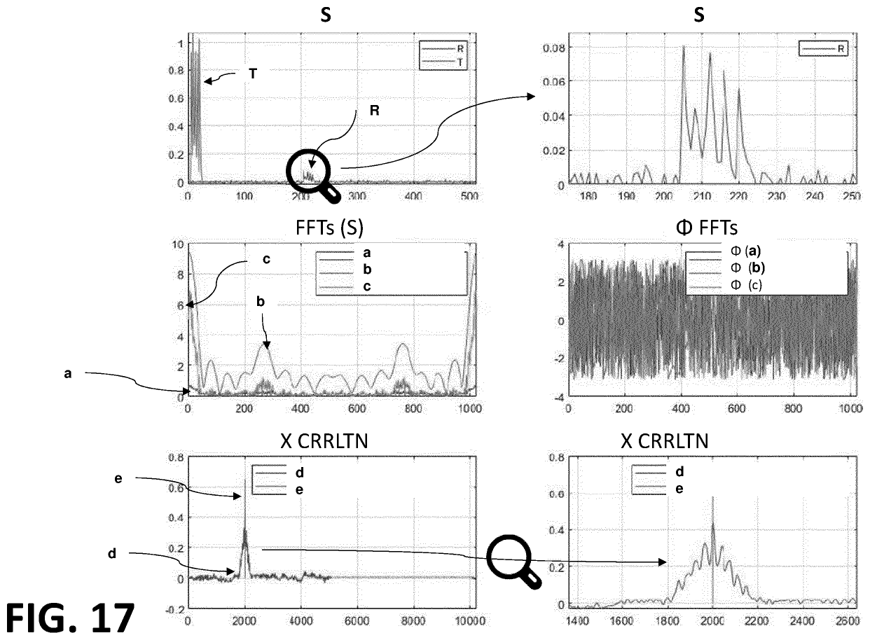

FIG. 17 represents same graphs as FIG. 16, for the simulation of the signals S of the pulse-train.

The foregoing discussion disclosed and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

1. A laser detection and ranging (LiDAR) device, comprising:
a transceiver assembly adapted to steer an incoming laser signal comprising a pulse-train of successive laser pulses onto a target, wherein each pulse has a rank in the pulse-train,
wherein each pulse is generated to have an optical energy, wherein the optical energy of a majority of the pulses of the pulse-train has substantially a same magnitude, and the optical energy of a trigger pulse in the pulse-train is higher than the optical energy of the majority of the pulses by a factor higher than 2, wherein the trigger pulse has a predefined rank in the pulse-train,
wherein the transceiver assembly is further configured to receive a return laser signal, which is a reflection of the incoming laser signal on the target,
the LiDAR device further comprising:
an optical detector adapted to acquire a detection signal by measuring an optical power of the return laser signal over the time,
a processing module adapted to perform a coarse detection step, comprising:
detecting that a measured optical power of the detection signal overcomes a predefined amplitude threshold at a trigger time, and recording the trigger time,
wherein the processing module is further adapted to perform a fine detection step, comprising:
selecting a time-window with reference to the trigger time, and
identifying a reflected pulse-train in the detection signal within the time window, by identifying that the trigger time corresponds to a detection time of a reflection of the trigger pulse.

2. The LiDAR device according to claim 1, wherein the incoming laser signal is a multispectral laser signal having a spectral range, and wherein each pulse in the incoming pulse-train has a pulse bandwidth centered on a different wavelength within the spectral range.

3. The LiDAR device according to claim 2, wherein the pulse bandwidth of the trigger pulse is broader than the pulse bandwidth of the majority of the pulses.

4. The LiDAR device according to claim 1, wherein the trigger pulse is spectrally centered on a wavelength which propagates through atmosphere with low attenuation.

5. The LiDAR device according to claim 1, wherein the trigger pulse is above 1400 nm in the spectral domain.

6. The LiDAR device according to claim 5, wherein the majority of the pulses of the pulse-train are below 1400 nm in the spectral domain.

7. The LiDAR device according to claim 1, wherein the predefined rank is the last rank, and the time-window ends after said trigger time.

8. The LiDAR device according to claim 1, wherein the predefined rank is the first rank, and the time-window starts from said trigger time.

9. The A-LiDAR device according to claim 1, wherein the pulse train further comprises a signature pulse having another predefined rank, the trigger pulse and the signature pulse being separated by a defined delay, wherein the optical energy of the signature pulse is also higher than the optical energy of the majority of the pulses, and wherein the coarse detection step further comprises:
detecting a second overcome of the predefined amplitude threshold, at the defined delay from the trigger pulse, prior to perform the fine detection step.

10. The LiDAR device according to claim 9, wherein the transceiver assembly is further configured to select a shape of the pulse-train, wherein the shape a trigger pulse is comprised between:
a first shape, wherein the trigger pulse is a single pulse of the pulse-train which has an optical energy higher than the optical energy of the rest of the pulses,
a second shape, wherein the pulse train comprises both the trigger pulse and the signature pulse,
wherein the transceiver assembly is further configured to select the second shape as a response of detecting that signal—noise ratio is higher than a predefined ratio threshold, for instance the predefined ratio threshold is higher than 8.

11. The LiDAR device according to claim 9, wherein the predefined rank is the first rank, and the time-window starts from said trigger time, and wherein the rank of the signature pulse is the last rank.

12. The LiDAR device according to claim 1, wherein the factor between the optical energy of the trigger pulse and the optical energy of the majority of the pulses is comprised between 2 and 10.

13. The LiDAR device according to claim 1, wherein the transceiver assembly comprises a laser emitting module configured to generate the incoming laser signal.

14. The LiDAR device according to claim 13, wherein the incoming laser signal is a multispectral laser signal having a spectral range, and
wherein each pulse in the incoming pulse-train has a pulse bandwidth centered on a different wavelength within the spectral range, and
wherein the laser emitting module comprises:
a broadband laser source, which is configured to generate an incoming broadband laser pulse, and
a superstructure fiber Bragg grating (FBG), wherein the superstructure FBG comprises a plurality of successive FBG portions, wherein each respective FBG portion is configured to reflect a respective pulse bandwidth centered on a respective different wavelength within the spectral range, wherein the superstructure FBG is configured to generate the pulse-train from the incoming broadband laser pulse.

15. The LiDAR device according to claim 14, wherein the FBG portion which is configured to reflect the trigger pulse has a periodic refractive index variation which has a bigger amplitude than periodic refractive index variations of the other FBG portions of the superstructure FBG, such that the pulse bandwidth of the trigger pulse is broader than the pulse bandwidth of the majority of the pulses.

16. The LiDAR device of claim 12, wherein the optical energy of the majority of the pulses is substantially equal to 5.

17. The LiDAR device according to claim 2, wherein the trigger pulse is spectrally centered on a wavelength which propagates through atmosphere with low attenuation.

18. The LiDAR device according to claim 3, wherein the trigger pulse is spectrally centered on a wavelength which propagates through atmosphere with low attenuation.

19. The LiDAR device according to claim 2, wherein the trigger pulse is above 1400 nm in the spectral domain.

20. The LiDAR device according to claim 3, wherein the trigger pulse is above 1400 nm in the spectral domain.
